(19) United States
(12) Patent Application Publication
(10) Pub. No.: US 2007/0019675 A1
(43) Pub. Date: Jan. 25, 2007

(54) System for rapid channel acquisition of broadcast digital media streams

(75) Inventor: Joseph W. Weber, San Francisco, CA (US)

Correspondence Address: PATTON BOGGS, 1660 LINCOLN ST, SUITE 2050, DENVER, CO, 80264, US

(73) Assignee: Cable Television Laboratories, Louisville, CO (US)

(21) Appl. No.: 11/175,529

(22) Filed: Jul. 6, 2005

(51) Int. Cl. H04J 3/22

(52) U.S. Cl. 370/468

(57) ABSTRACT

The present channel acquisition system rapidly acquires and decodes digital media streams that are broadcast to customers, such as the digital media streams delivered by streaming media and traditional broadcast media services like cable, satellite, and broadcast television. When the decoding unit makes a channel change or initiates reception of a selected channel, the decoding unit receives the necessary Reference Frames and Dependent Frames on a separate channel such that it can start decoding faster than if it waited for those frames to arrive on the selected channel via the broadcast stream. There are several embodiments of the channel acquisition system which provide various forms of data on the separate channel to enable the rapid acquisition of the selected channel by the decoding unit. These forms of data include a burst of the required Reference Frames and Dependent Frames, multiple broadcast streams of the same channel that contain Reference Frames at different offset times, and a single additional broadcast stream that contains only the necessary Reference Frames and Dependent Frames for decoding. These various methods of providing the required decoding information to supplement the digital stream received on the selected channel enables the decoder to quickly initiate decoding and display of the received digital bit stream to the customer.

### FIELD OF THE INVENTION

This invention relates to systems that process digital media streams which are broadcast by digital mass media distribution networks, such as digital media streams delivered by streaming media, and traditional broadcast media services like cable, satellite, and broadcast television.

### PROBLEM

It is a problem in digital mass media distribution networks to rapidly acquire and decode digital media streams that are broadcast to customers, such as the digital media streams delivered by streaming media and traditional broadcast media services like cable, satellite, and broadcast television. These digital media streams can be, for example, television channels for display to customers on their television sets.

Digital mass media distribution networks consist of encoding, broadcasting, receiving, and decoding units that use a digital network to deliver multi-media content to selected customers. The encoding unit takes the multi-media content in the form of an analog media stream and encodes the multi-media content into a digital bit stream, which is then broadcast by the broadcasting unit to a multitude of destinations over a digital network that concurrently carries many digital bit streams. The receiving unit is connected to the digital network and functions to receive a selected one of the concurrently broadcast digital bit streams, termed a “channel”, and the decoding unit then decodes the received digital bit stream contained in that channel back into an analog media stream for delivery to the selected customer.

The digital bit stream (consisting of audio and/or video content) created by the encoding unit consists of a stream of bits. In uncompressed format, these bits correspond to the digital representation of an analog audio and/or video stream. The digital representation consists of a series of discrete digital frames, each of which corresponds to a discrete time sample of the analog audio and/or video stream. For example, analog audio and/or video streams typically are sampled 30 times per second to create corresponding analog audio and/or video time samples. The digital representation of an analog audio and/or video time sample is then compressed such that the resulting number of bits per digital frame is significantly less than the uncompressed representation of the analog audio and/or video time sample. The compressed digital frames typically consist of a variable number of bits, while the uncompressed digital frames are typically a fixed number of bits.

As part of the compression process, the compressed digital frames consist of one of the following types of frames: (1) Reference Frames (RF) which can be converted back into uncompressed digital frames using only the bits contained in the Reference Frames, and (2) Dependent Frames (DF) which can only be converted back into uncompressed digital frames using the bits from itself, possibly other Dependent Frames, and at least one Reference Frame. As a result, in order to start decoding a stream of digital frames contained in a selected channel, it is necessary to wait until at least one Reference Frame and possibly multiple Dependent Frames are received. This time interval before decoding can be initiated is termed “coding acquisition delay”. It occurs whenever acquisition and decoding of a new channel is initiated, such as during a channel change. There is also a time interval between when the necessary Reference Frames and Dependent Frames have been received and when they are decompressed and converted back into uncompressed digital frames. This is termed the “decompression delay”. These combined delays are termed “channel acquisition delay” and can result in a time interval of several analog sample time frames before the decoding and display of the received digital bit stream can occur. When there are multiple channels of broadcast digital media, changing between these digital bit streams (also referred to as channels) produces a noticeable delay because of the channel acquisition delay and decompression delay. This can be annoying to the customer and prevents practical use of channel “surfing” where the customer wants to rapidly change between multiple streams/channels, especially since customers are accustomed to being able to rapidly change channels under analog systems. Therefore, there is an economic value in being able to provide this same feature with broadcast digital media.

Thus, the present mass media distribution networks are unable to rapidly acquire and decode digital media streams that are broadcast to customers and incur a series of delays each time a customer initiates reception of a selected channel.

### SOLUTION

The above-described problems are solved and a technical advance achieved by the present system for rapid channel acquisition of broadcast digital media streams, termed “channel acquisition system” herein, which rapidly acquires and decodes digital media streams that are broadcast to customers, such as the digital media streams delivered by streaming media and traditional broadcast media services like cable, satellite, and broadcast television.

In the present channel acquisition system, when the decoding unit makes a channel change or initiates reception of a selected channel, the decoding unit receives the necessary Reference Frames and Dependent Frames on a separate channel, thereby reducing the coding acquisition delay and enabling the start of decoding faster than if it waited for those frames to arrive on the selected channel via the broadcast stream. There are several embodiments of the channel acquisition system which provide various forms of data on the separate channel to enable the rapid acquisition of the selected channel by the decoding unit. These forms of data include a burst of the required Reference Frames and Dependent Frames, multiple broadcast streams of the same channel that contain Reference Frames at different offset times, and a single additional broadcast stream that contains only the necessary Reference Frames and Dependent Frames for decoding. These various methods of providing the required decoding information to supplement the digital stream received on the selected channel enables the decoder to quickly initiate decoding and display of the received digital bit stream to the customer.

### BRIEF DESCRIPTION OF THE DRAWINGS

FIG. 1 illustrates in block diagram form a typical digital mass media distribution network;

FIG. 2 illustrates a signal flow diagram that shows the relationship between Reference Frames and Dependent Frames in a typical digital mass media distribution network;

FIG. 3 illustrates a signal flow diagram that shows the relationship between Reference Frames and Dependent Frames in a typical digital mass media distribution network, with the associated coding acquisition delay and decompression delay;

FIG. 4 illustrates, in flow diagram form, the operation of the present channel acquisition system;

FIG. 5 illustrates a signal flow diagram that shows the relationship between Reference Frames and Dependent Frames in a first embodiment of the present channel acquisition system;

FIG. 6 illustrates a signal flow diagram that shows the relationship between Reference Frames and Dependent Frames in a second embodiment of the present channel acquisition system; and

FIG. 7 illustrates a signal flow diagram that shows the relationship between Reference Frames and Dependent Frames in a third embodiment of the present channel acquisition system.

### DETAILED DESCRIPTION OF THE DRAWINGS

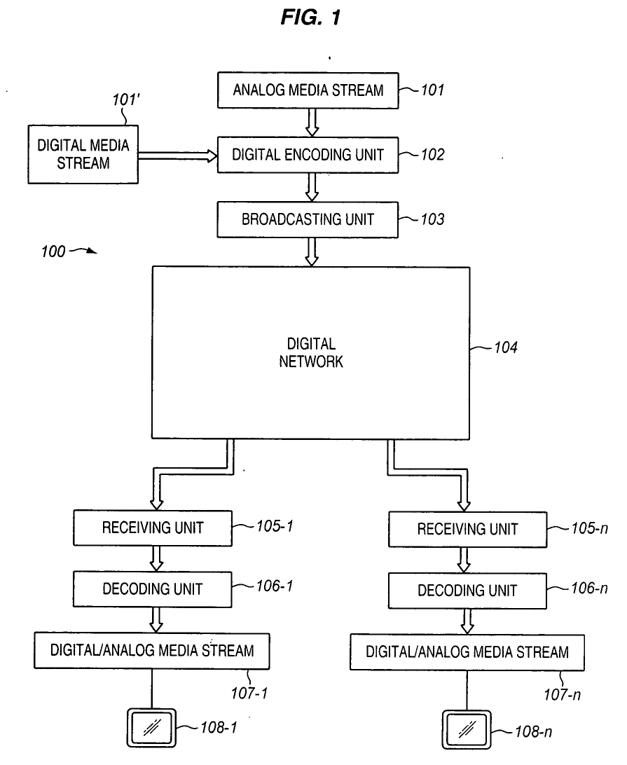

FIG. 1 illustrates in block diagram form a typical digital mass media distribution network 100. Digital mass media distribution networks consist of digital encoding 102, broadcasting 103, receiving 105, and digital decoding 106 units that use a digital network 104 to deliver multi-media content to selected customers. The digital encoding unit 102 takes the multi-media content in the form of an analog media stream 101 (or a digital media stream 101′) and encodes the multi-media content into a compressed digital bit stream, which is then broadcast by the broadcasting unit 103 to a multitude of destinations over a digital network 104 that concurrently carries many digital bit streams. The receiving units 105-1 to 105-n are connected to the digital network 104 and function to receive a selected one of the concurrently broadcast digital bit streams, termed a “channel”, and the digital decoding units 106-1 to 106-n then decode the received digital bit stream contained in that channel back into an analog or uncompressed digital media stream 107-1 to 107-n for delivery to a terminal device 108-1 to 108-n of the selected customer. In a broadcast environment, the bits of compressed digitized frame units are transmitted at a rate such that frame units are received on average one per frame unit interval of time.

Reference Frames and Dependent Frames

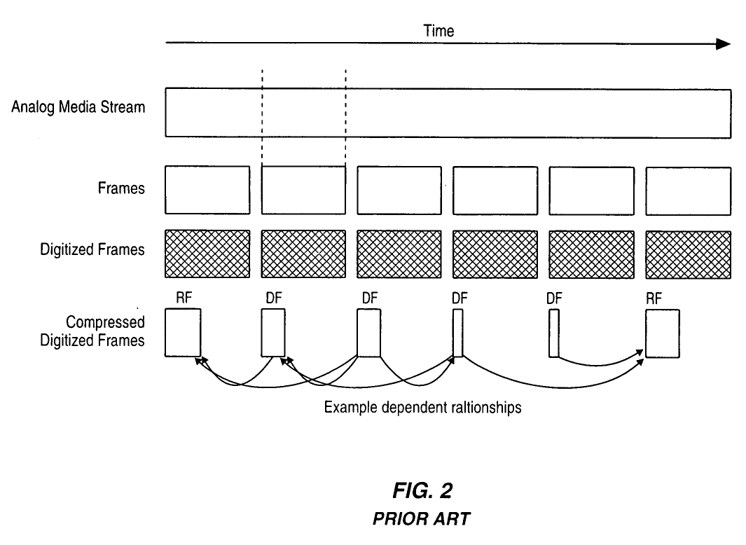

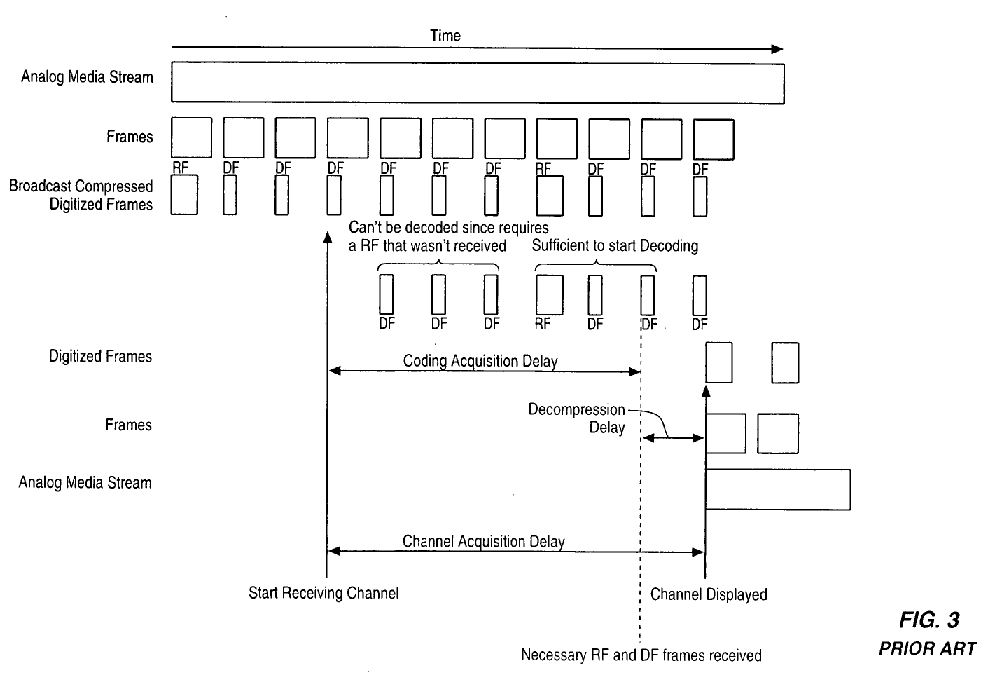

FIG. 2 illustrates a signal flow diagram that shows the relationship between Reference Frames and Dependent Frames in a typical digital mass media distribution network 100, and FIG. 3 illustrates a signal flow diagram that shows the relationship between Reference Frames and Dependent Frames in a typical digital mass media distribution network 100, with the associated coding acquisition delay and decompression delay.

The Analog Media Stream 101 comprises the multi-media content that is delivered to the digital encoding unit 102, typically as a continuous stream as illustrated by the Time line in FIGS. 2 and 3. The Analog Media Stream 101 is divided into Frames, each comprising a discrete time sample of the Analog Media Stream 101. The digital representation of the samples of the Analog Media Stream 101 consists of a series of discrete digital frames, each of which corresponds to a discrete time sample of the analog audio and/or video stream. The digital representation of an analog audio and/or video time sample is then compressed such that the resulting number of bits per digital frame is significantly less than the uncompressed representation of the analog audio and/or video time sample. The compressed digital frames typically consist of a variable number of bits, while the uncompressed digital frames are typically a fixed number of bits. Alternatively, the multi-media content can be presented in the form of a digital bit stream comprising uncompressed digital frames.

As part of the compression process, the compressed digital frames consist of one of the following types of frames: (1) Reference Frames (RF) which can be converted back into uncompressed digital frames using only the bits contained in the Reference Frames, and (2) Dependent Frames (DF) which can only be converted back into uncompressed digital frames using the bits from itself, possibly other Dependent Frames, and at least one Reference Frame, as indicated by the arrows on FIG. 2 that interconnect various ones of the Reference Frames and Dependent Frames.

As a result, in order to start decoding a stream of digital frames contained in a selected channel, it is necessary to wait until at least one Reference Frame and possibly multiple Dependent Frames are received, as shown in FIG. 3. This time interval before decoding can be initiated is termed “coding acquisition delay”. It occurs whenever acquisition and decoding of a new channel is initiated, such as during a channel change. There is also a time interval between when the necessary Reference Frames and Dependent Frames have been received and when they are decompressed and converted back into uncompressed digital frame units. This is termed the “decompression delay”. These combined delays are termed “channel acquisition delay”, and can result in a time interval of several frame time units before the decoding of the received digital bit stream can occur.

Supplemental Reference Frames And Dependent Frames

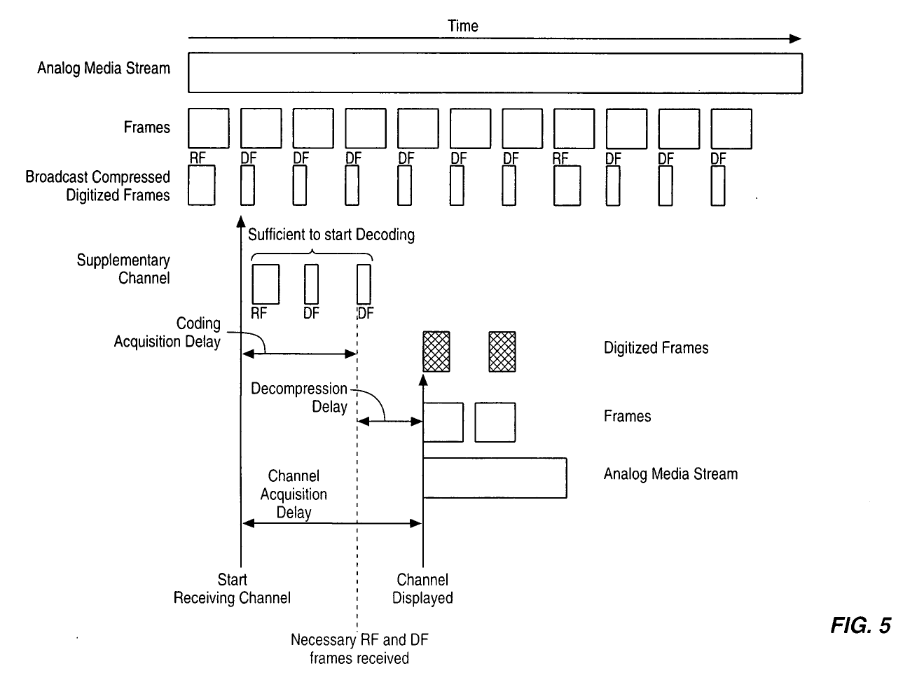

FIG. 5 illustrates a signal flow diagram that shows the relationship between the digital bit stream contained in the selected channel and the supplemental Reference Frames and Dependent Frames in a first embodiment of the present channel acquisition system. In this embodiment, the broadcasting unit bursts the Reference Frames and Dependent Frames required for decoding in a separate channel such that the decoding unit can immediately begin displaying the received digital bit stream. This requires that a signal be transmitted from the decoding unit to the broadcasting unit requesting that the broadcasting unit initiate the data burst for the channel selected by the customer. In order to return the requested supplemental Reference Frames and Dependent Frames from the broadcasting unit to the requesting decoding unit, a separate digital bit stream (such as a supplemental channel) must be provided that can contain the requested data burst for the selected channel. The decoding unit receives the required supplemental Reference Frames and Dependent Frames via the burst stream of data, and starts receiving the rest of the digital bit stream via the normal broadcast stream.

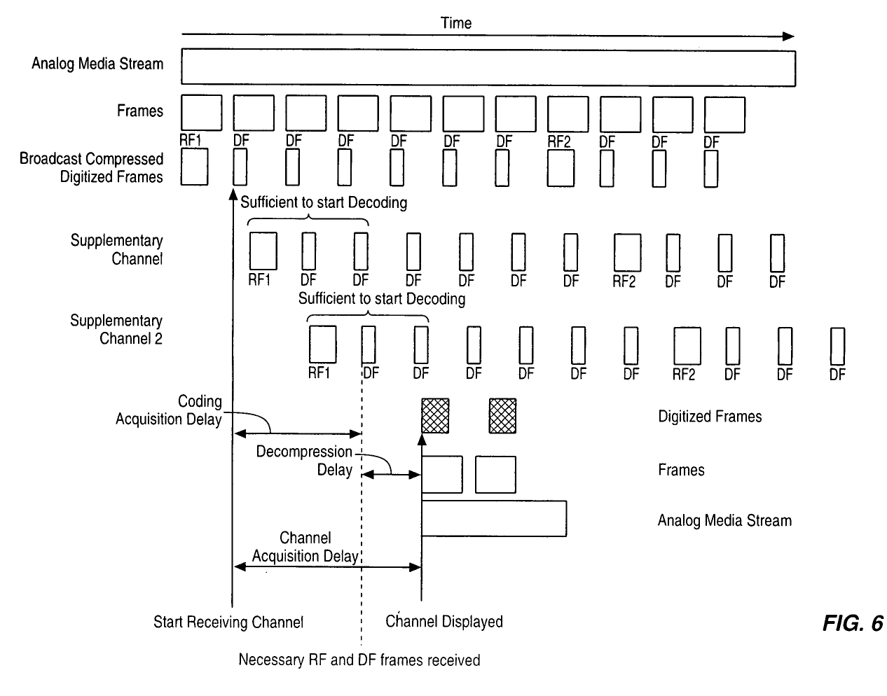

FIG. 6 illustrates a signal flow diagram that shows the relationship between Reference Frames and Dependent Frames in a second embodiment of the present channel acquisition system. In this embodiment, there exists multiple broadcast streams (additional channels labeled Supplementary Channel 1 and 2) of the same channel that contain Reference Frames at different offset times. The receiver unit tunes to the multiple broadcast streams and finds the stream with the shortest wait period for the necessary Reference Frames and Dependent Frames to start decoding.

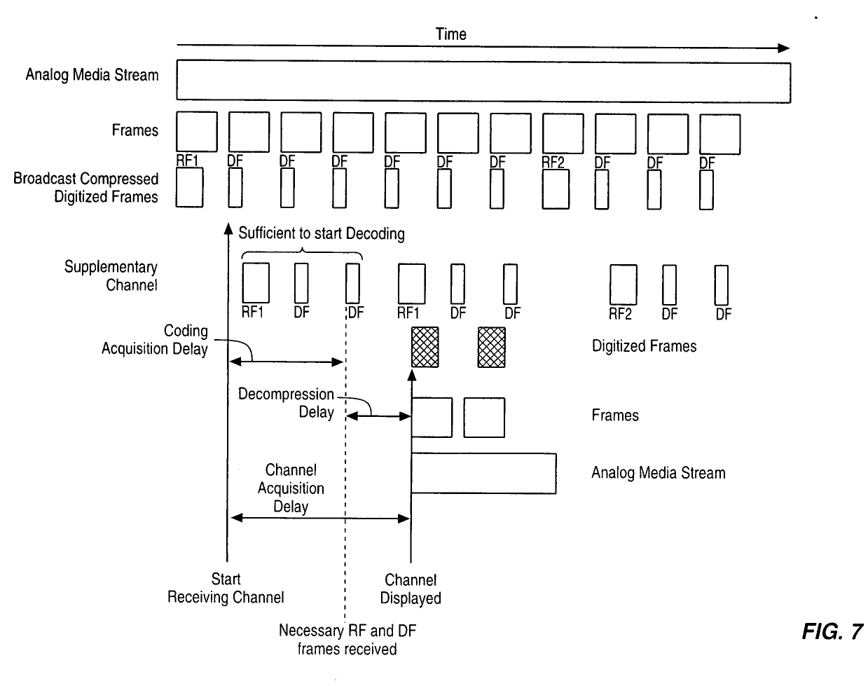

FIG. 7 illustrates a signal flow diagram that shows the relationship between Reference Frames and Dependent Frames in a third embodiment of the present channel acquisition system. In this embodiment, there exists a single additional broadcast stream (Supplementary Channel) that contains only the necessary Reference Frames and Dependent Frames for decoding. The decoder unit tunes to both the normal broadcast stream and the additional stream to receive all the frames necessary for decoding. Once decoding begins, the receiver receives only the normal digital bit stream on the selected channel. The additional necessary frames are rebroadcast, as shown in the stream RF1, DF, DF, RF1, DF, DF, RF2, DF, DF, etc. Thus, the additional frames are updated when the broadcast channel carries a new Reference Frame, RF1, then RF2, etc.

Operation Of The Present Channel Acquisition System

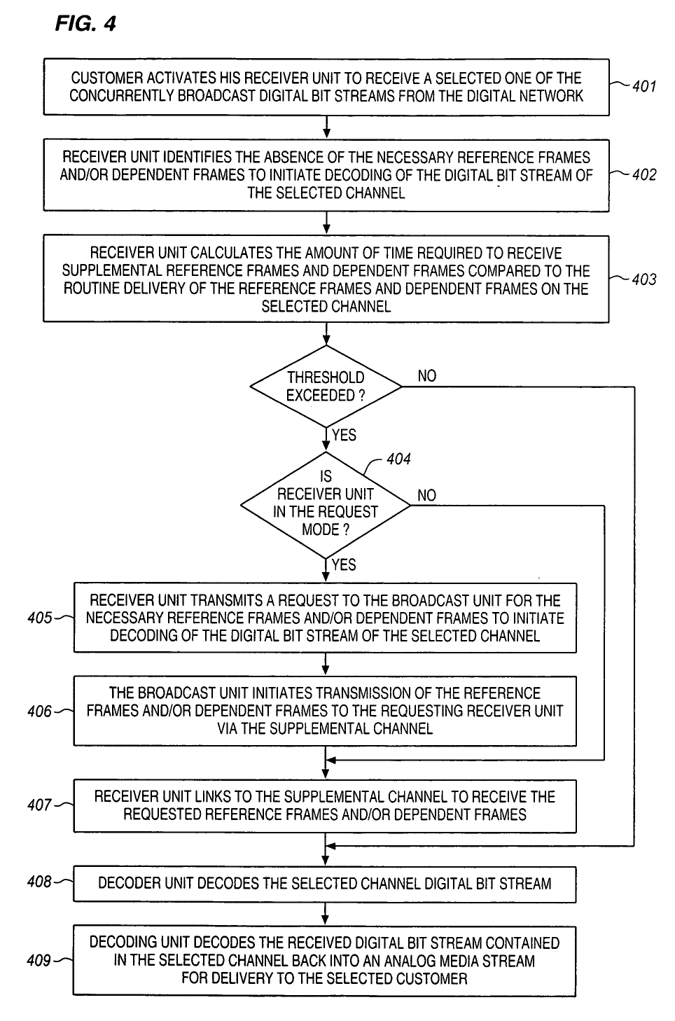

FIG. 4 illustrates, in flow diagram form, the operation of the present channel acquisition system. At step 401, the customer activates their receiver unit to receive a selected one of the concurrently broadcast digital bit streams, termed a “channel”, from the digital network. At step 402, the receiver unit identifies the absence of the necessary Reference Frames and/or Dependent Frames to initiate decoding of the digital bit stream of the selected channel. At step 403, the receiver unit calculates the amount of time required to receive supplemental Reference Frames and Dependent Frames compared to the routine delivery of the Reference Frames and Dependent Frames on the selected channel. If receipt of the Reference Frames and Dependent Frames on the selected channel is imminent, then processing advances to step 407.

If the present channel acquisition system operates in a request mode as determined at step 404, and receipt of Reference Frames and Dependent Frames on the selected channel is not imminent, the receiver unit at step 405 optionally transmits a request to the broadcast unit for the necessary Reference Frames and/or Dependent Frames to initiate decoding of the digital bit stream of the selected channel. In response to the request originated at step 405, the broadcast unit at step 406 initiates transmission of the Reference Frames and/or Dependent Frames to the requesting receiver unit via the supplemental channel. At step 407, the receiver unit links to the supplemental channel to receive the requested Reference Frames and/or Dependent Frames. At step 408, in response to receipt of the requested Reference Frames and/or Dependent Frames by the receiver unit, the decoder unit initiates decoding of the digital bit stream of the selected channel. The decoding unit decodes the received digital bit stream contained in the selected channel back into an analog media stream for delivery to the selected customer at step 409.

Alternatively, steps 405 and 406 can be eliminated if the present channel acquisition system does not utilize a request driven delivery of the supplemental Reference Frames and Dependent Frames as determined at step 404.

Summary

The present channel acquisition system rapidly acquires and decodes digital media streams that are broadcast to customers by having the decoder unit receive the necessary Reference Frames and Dependent Frames on a separate channel such that it can start decoding faster than if it waited for the those units to arrive on the selected channel via the broadcast stream.

What is claimed:

1. In a digital media distribution network that transmits a plurality of channels, each containing a digitally encoded bit stream comprising a stream of reference frames with interposed and associated dependent frames, wherein contents of a reference frame are necessary to decode contents of successively received dependent frames, a channel acquisition system for initiating decoding of dependent frames present on a selected one of said plurality of channels absent receipt of a reference frame on said selected channel, comprising:
coding presence means, responsive to selection of one of said plurality of channels, for determining the presence of a one of said reference frames on said selected channel;
coding acquisition means, responsive to the absence of a reference frame from said selected channel, for retrieving said reference frame from a supplementary channel in said digital media distribution network; and
decoding means, responsive to retrieval of said reference frame from said supplementary channel, for decoding dependent frames present on said selected channel.

2. The channel acquisition system of claim 1 wherein said coding acquisition means comprises:
request means for transmitting a message to a source of said digitally encoded bit stream on a selected one of said plurality of channels to request said reference frame; and
reference frame receiving means, responsive to the appearance on a supplementary channel in said digital media distribution network of said reference frame for said selected channel, for retrieving said reference frame from said supplementary channel in said digital media distribution network.

3. The channel acquisition system of claim 1 wherein said coding acquisition means comprises:
supplementary channel select means for monitoring at least one supplementary channel to detect appearance of said reference frame; and
reference frame receiving means, responsive to the appearance on a one of said at least one supplementary channel in said digital media distribution network of said reference frame for said selected channel, for retrieving said reference frame from said supplementary channel in said digital media distribution network.

4. The channel acquisition system of claim 1 wherein said coding acquisition means comprises:
supplementary channel select means for monitoring a supplementary channel to detect appearance of said reference frame; and
reference frame receiving means, responsive to the appearance on a said supplementary channel in said digital media distribution network of said reference frame for said selected channel, for retrieving said reference frame from said supplementary channel in said digital media distribution network.

5. In a digital media distribution network that transmits a plurality of channels, each containing a digitally encoded bit stream comprising a stream of reference frames with interposed and associated dependent frames, wherein contents of a reference frame are necessary to decode contents of successively received dependent frames, a method of operating a channel acquisition system for initiating decoding of dependent frames present on a selected one of said plurality of channels absent receipt of a reference frame on said selected channel, comprising:
determining, in response to selection of one of said plurality of channels, for determining the presence of a one of said reference frames on said selected channel;
retrieving, in response to the absence of a reference frame from said selected channel, said reference frame from a supplementary channel in said digital media distribution network; and
decoding, in response to retrieval of said reference frame from said supplementary channel, dependent frames present on said selected channel.

6. The method of operating a channel acquisition system of claim 5 wherein said step of retrieving comprises:
transmitting a message to a source of said digitally encoded bit stream on a selected one of said plurality of channels to request said reference frame; and
retrieving, in response to the appearance on a supplementary channel in said digital media distribution network of said reference frame for said selected channel, said reference frame from said supplementary channel in said digital media distribution network.

7. The method of operating a channel acquisition system of claim 5 wherein said step of retrieving comprises:
monitoring at least one supplementary channel to detect appearance of said reference frame; and
retrieving, in response to the appearance on a one of said at least one supplementary channel in said digital media distribution network of said reference frame for said selected channel, said reference frame from said supplementary channel in said digital media distribution network.

8. The method of operating a channel acquisition system of claim 5 wherein said step of retrieving comprises:
monitoring a supplementary channel to detect appearance of said reference frame; and
retrieving, in response to the appearance on a said supplementary channel in said digital media distribution network of said reference frame for said selected channel, said reference frame from said supplementary channel in said digital media distribution network.

9. In a digital media distribution network that transmits a plurality of channels, each containing a digitally encoded bit stream comprising a stream of reference frames with interposed and associated dependent frames, from a broadcasting unit over a digital network to at least one receiving unit connected to said digital network, wherein contents of a reference frame are necessary to decode contents of successively received dependent frames, a channel acquisition system for initiating decoding of dependent frames present on a selected one of said plurality of channels absent receipt of a reference frame on said selected channel, comprising:
coding presence means, located in said receiving unit and responsive to selection of one of said plurality of channels, for determining the presence of a one of said reference frames on said selected channel;
coding acquisition means, located in said receiving unit and responsive to the absence of a reference frame from said selected channel, for retrieving said reference frame from a supplementary channel in said digital media distribution network; and
decoding means, located in a decoding unit and responsive to retrieval of said reference frame from said supplementary channel, for decoding dependent frames present on said selected channel.

10. The channel acquisition system of claim 9 wherein said coding acquisition means comprises:
request means for transmitting a message to said broadcasting unit which is the source of said digitally encoded bit stream on a selected one of said plurality of channels to request said reference frame; and
reference frame receiving means, responsive to the appearance on a supplementary channel in said digital media distribution network of said reference frame for said selected channel, for retrieving said reference frame from said supplementary channel in said digital media distribution network.

11. The channel acquisition system of claim 9 wherein said coding acquisition means comprises:
supplementary channel select means for monitoring at least one supplementary channel to detect appearance of said reference frame; and
reference frame receiving means, responsive to the appearance on a one of said at least one supplementary channel in said digital media distribution network of said reference frame for said selected channel, for retrieving said reference frame from said supplementary channel in said digital media distribution network.

12. The channel acquisition system of claim 9 wherein said coding acquisition means comprises:
supplementary channel select means for monitoring a supplementary channel to detect appearance of said reference frame; and
reference frame receiving means, responsive to the appearance on a said supplementary channel in said digital media distribution network of said reference frame for said selected channel, for retrieving said reference frame from said supplementary channel in said digital media distribution network.
